(19) United States
(12) Patent Application Publication
(10) Pub. No.: US 2025/0271385 A1
(43) Pub. Date: Aug. 28, 2025

(54) GAS SENSOR

(71) Applicant: TDK Corporation, Tokyo (JP)

(72) Inventor: Kei TANABE, Tokyo (JP)

(21) Appl. No.: 19/197,139

(22) Filed: May 2, 2025

Related U.S. Application Data
(63) Continuation of application No. PCT/JP2022/043919, filed on Nov. 29, 2022.

(51) Int. Cl. G01N 27/14; G01N 33/00

(52) U.S. Cl. CPC G01N 27/14; G01N 33/0027

(57) ABSTRACT

Disclosed herein is a gas sensor that includes: first and second thermistors connected in series; first and second heaters configured to heat the first and second thermistors, respectively; and a control circuit configured to control the first and second heaters. In a first period, the control circuit is configured to: heat the second heater to a higher temperature than a heating temperature of the first heater; generate an output signal indicating a concentration of a gas to be measured based on a detection signal appearing at a connection point between the first and second thermistors in a state where the second heater is heated to a higher temperature than the first heater; and make a heating time of the first heater shorter than a heating time of the second heater.

### BACKGROUND OF THE ART

### Field of the Art

The present disclosure relates to a gas sensor.

### Description of Related Art

International Publication WO 2020/031517 discloses a gas sensor configured to calculate the concentration of a gas to be measured based on the level of a detection signal appearing at the connection point of two series-connected thermistors. The gas sensor described in International Publication WO 2020/031517 heats a thermistor constituting a detection element and a thermistor constituting a reference element to 150° C. and 300° C., respectively, to acquire a detection signal.

Like the gas sensor described in International Publication WO 2020/031517, gas sensors of a type that heats a thermistor during measurement is required to reduce power consumption.

### SUMMARY

A gas sensor according to the present disclosure includes: first and second thermistors connected in series; first and second heaters configured to heat the first and second thermistors, respectively; and a control circuit configured to control the first and second heaters. In a first period, the control circuit is configured to: heat the second heater to a higher temperature than a heating temperature of the first heater; generate an output signal indicating a concentration of a gas to be measured based on a detection signal appearing at a connection point between the first and second thermistors in a state where the second heater is heated to a higher temperature than the first heater; and make a heating time of the first heater shorter than a heating time of the second heater.

### BRIEF DESCRIPTION OF THE DRAWINGS

The above features and advantages of the present disclosure will be more apparent from the following description of some embodiments taken in conjunction with the accompanying drawings, in which:

FIG. 1 is a circuit diagram illustrating the configuration of a gas sensor 1 according to a first embodiment of the technology described herein;

FIG. 2 is a timing chart for explaining the operation of the gas sensor 1;

FIG. 3 is a graph illustrating the temperature characteristics of the thermistors Rd1 and Rd2;

FIG. 4 is a graph illustrating the relation between the temperature of the thermistors Rd1, Rd2 and their sensitivity to CO₂ gas;

FIG. 5 is a graph for explaining a temporal change of the heating temperature of the thermistors Rd1 and Rd2 in period A; and

FIG. 6 is a circuit diagram illustrating the configuration of a gas sensor 2 according to a second embodiment of the technology described herein.

### DETAILED DESCRIPTION OF THE EMBODIMENTS

The present disclosure describes a technology for reducing power consumption in a gas sensor of a type that heats a thermistor during measurement.

Some embodiments of the present disclosure will be explained below in detail with reference to the accompanying drawings.

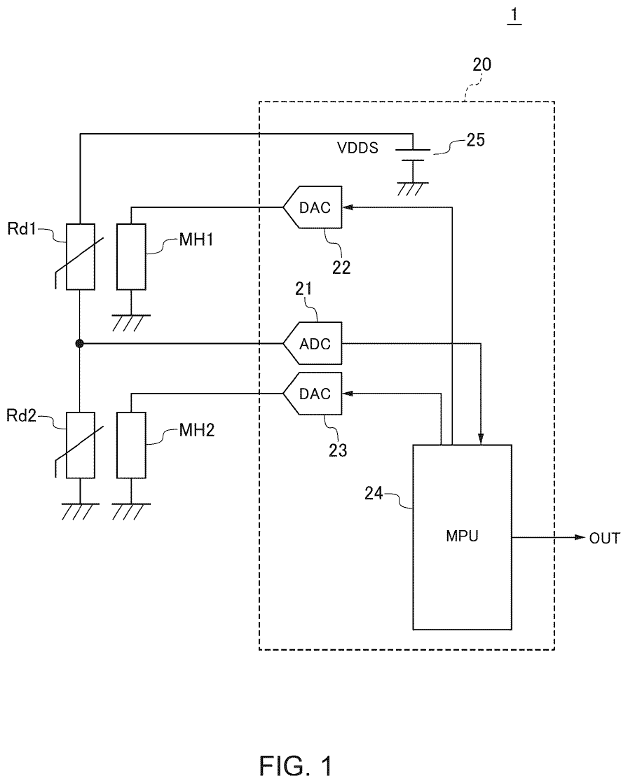

FIG. 1 is a circuit diagram illustrating the configuration of a gas sensor 1 according to a first embodiment of the technology described herein.

As illustrated in FIG. 1, the gas sensor 1 according to the first embodiment includes thermistors Rd1 and Rd2, heater resistors MH1 and MH2 for heating the thermistors Rd1 and Rd2, respectively, and a control circuit 20 for controlling the heater resistors MH1 and MH2. Although not particularly limited, the gas sensor 1 according to the present embodiment is a thermal conduction type gas sensor for detecting the concentration of CO₂ gas in the atmosphere.

The thermistors Rd1 and Rd2 are detection elements made of a material having a negative temperature coefficient of resistance, such as a composite metal oxide, amorphous silicon, polysilicon, or germanium. Both the thermistors Rd1 and Rd2 detect the concentration of CO₂ gas, but have different operating temperatures, as described below. Here, the thermistor Rd1 constitutes a detection element, and the thermistor Rd2 constitutes a reference element. The thermistors Rd1 and Rd2 are connected in series between a power supply 25 for supplying a power supply potential VDDS and a ground, and a detection signal appearing at the connection point between the thermistors Rd1 and Rd2 is supplied to the control circuit 20.

The control circuit 20 includes an AD converter (ADC) 21, DA converters (DAC) 22 and 23, an MPU 24, and the power supply 25. The AD converter 21 AD-converts a detection appearing at the connection point between the 15 signal thermistors Rd1 and Rd2 and supplies an obtained digital value to the MPU 24. Based on the supplied AD-converted detection signal, the MPU 24 generates an output signal OUT indicating the concentration of CO₂ gas. The DA converters 22 and 23 DA-convert the digital value supplied from the MPU 24 to apply predetermined voltages to the heater resistors MH1 and MH2, respectively. In other words, the heating temperatures of the heater resistors MH1 and MH2 are controlled by the MPU 24.

The following describes the operation of the gas sensor 1 according to the present embodiment.

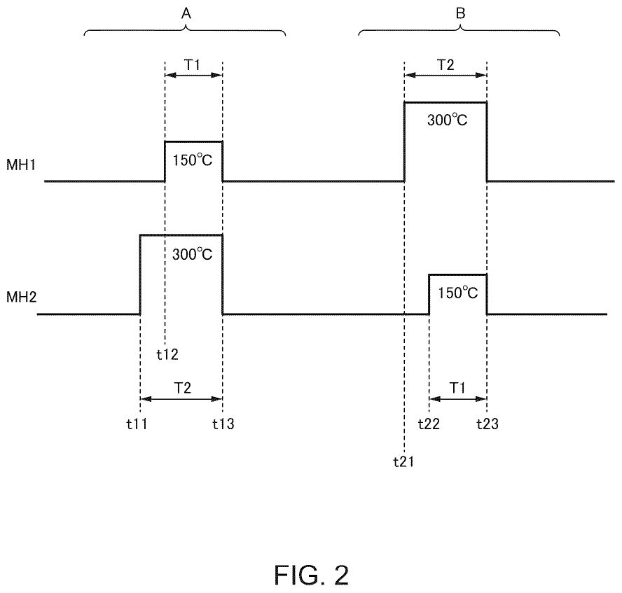

FIG. 2 is a timing chart for explaining the operation of the gas sensor 1 according to the present embodiment.

As illustrated in FIG. 2, the gas sensor 1 according to the present embodiment performs gas measurement operation in period A and performs dummy heating operation in period B. The gas measurement operation and dummy heating operation are alternately performed.

During the gas measurement operation performed in period A, heater resistors MH1 and MH2 are heated to 150° C. and 300° C., respectively, under the control of MPU 24. The heater resistor MH1 and thermistor Rd1 are disposed in close proximity to each other and thus, the temperature of the heater resistor MH1 can be regarded as substantially the same as the temperature of the thermistor Rd1. Similarly, the heater resistor MH2 and thermistor Rd2 are disposed in close proximity to each other and thus, the temperature of the heater resistor MH2 can be regarded as substantially the same as the temperature of the thermistor Rd2.

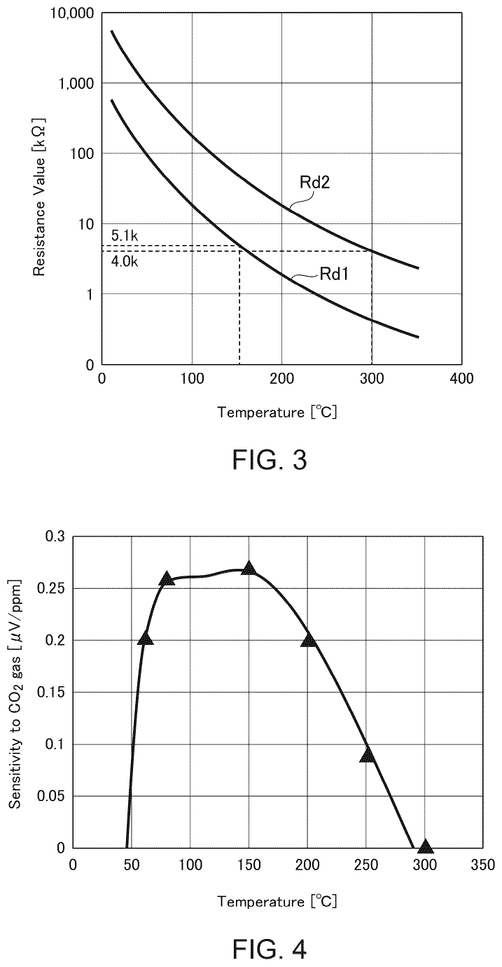

As illustrated in FIG. 3, the temperature characteristics of the thermistors Rd1 and Rd2 are mutually different and designed such that the resistance value of the thermistor Rd1 heated to 150° C. and the resistance value of the thermistor Rd2 heated to 300° C. are close to each other. In the example illustrated in FIG. 3, the resistance value of the thermistor Rd1 heated to 150° C. is 5.1 kΩ, and the resistance value of the thermistor Rd2 heated to 300° C. is 4.0 kΩ. The resistance value of thermistor Rd1 heated to 150° C. and the resistance value of thermistor Rd2 heated to 300° C. may be approximately the same.

FIG. 4 is a graph illustrating the relation between the temperature of the thermistors Rd1, Rd2 and their sensitivity to CO₂ gas. As can be seen from the graph of FIG. 4, the sensitivity of the thermistors Rd1 and Rd2 to CO₂ gas varies significantly depending the on temperature, and the sensitivity of the thermistors Rd1, Rd2 to CO₂ gas is almost zero in the temperature range below 40° C. or above 300° C. The sensitivity of the thermistors Rd1, Rd2 to CO₂ gas is maximum at about 150° C.

When CO₂ gas is present in the measurement atmosphere with the thermistor Rd1 as the detection element heated to 150° C., the heat dissipation characteristics of the thermistor Rd1 change according to the concentration. Such a change appears as a change in the resistance value of the thermistor Rd1. On the other hand, even when CO₂ gas is present in the measurement atmosphere with the thermistor Rd2 as the reference element heated to 300° C., the heat dissipation characteristics of the thermistor Rd2 hardly change according to the concentration. Therefore, the change in the resistance value of the thermistor Rd2 heated to 300° C. due to the concentration of CO₂ gas is sufficiently smaller than the change in the resistance value of the thermistor Rd1 heated to 150° C. due to the concentration of CO₂ gas. There is no problem if the resistance value of the thermistor Rd2 heated to 300° C. due to the concentration of CO₂ gas hardly changes.

As a result, the level of the detection signal appearing at the connection point between the thermistors Rd1 and Rd2 being heated changes according to the concentration of CO₂ gas in the measurement atmosphere. The detection signal is supplied to the MPU 24 through the AD converter 21, and the MPU 24 generates an output signal OUT indicating the concentration of CO₂ gas based on the supplied detection signal.

During the gas measurement operation performed in period A, the heating start timing of the heater resistor MH2 is time t11, the heating start timing of the heater resistor MH1 is time t12, and the heating end timing of the heater resistors MH1 and MH2 is time t13. Thus, the heater resistor MH1 is heated during period T1 from time t12 to time t13, and the heater resistor MH2 is heated during period T2 from time t11 to time t13.

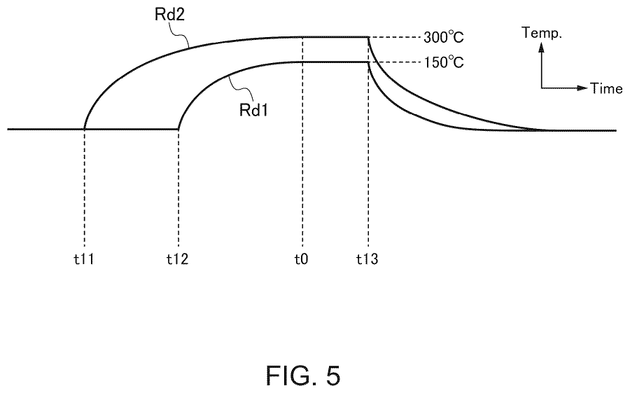

FIG. 5 is a graph for explaining a temporal change of the heating temperature of the thermistors Rd1 and Rd2 in period A.

As illustrated in FIG. 5, when the heating of the heater resistor MH2 is started at time t11, the temperature of the thermistor Rd2 rises. However, a predetermined time is required until the temperature of the thermistor Rd2 reaches a target value of 300° C. In the example of FIG. 5, the temperature of the thermistor Rd2 reaches the target value of 300° C. at time to. When the heating of the heater resistor MH1 is started at time t12 later than time t11, the temperature of the thermistor Rd1 rises. However, a predetermined time is required until the temperature of the thermistor Rd1 reaches a target value of 150° C. The heating temperature of the thermistor Rd1 is lower than that of the thermistor Rd2, so that the time required for the temperature of the thermistor Rd1 to reach the target value of 150° C. is shorter than the time required for the temperature of the thermistor Rd2 to reach the target value of 300° C. In the example of FIG. 5, the temperature of the thermistor Rd1 reaches the target value of 150° C. at time to. Accordingly, both the thermistors Rd1 and Rd2 are heated to their target temperatures at and after time to.

After that, the heating of the heater resistor MH1 and heating of the heater resistor MH2 end simultaneously at time t13. Therefore, both the thermistors Rd1 and Rd2 are properly heated to their target temperatures during time to to time 13, and a detection signal obtained in this period is sampled by the MPU 24.

As described above, in period A, the heater resistor MH2 to be heated to a higher temperature starts being heated earlier than the heater resistor MH1, so that timings (time t0) at which both the thermistors Rd1 and Rd2 are heated to their target temperatures can be made to substantially coincide with each other. Thus, as compared with when the heater resistors MH1 and MH2 start being heated simultaneously, the heating time of the heater resistor MH1 can be reduced to reduce power consumption. In addition, since the heating time of the heater resistor MH1 is thus reduced, the aging of the heater resistor MH1 can also be suppressed. Note that timings at which both the thermistors Rd1 and Rd2 are heated to their target temperatures need not completely coincide with each other, but it is sufficient that the heating start timing of the heater resistor MH1 is made later than the heating start timing of the heater resistor MH2 to reduce the difference between the timing at which the thermistor Rd1 is heated to its target temperature and the timing at which the thermistor Rd2 is heated to its target temperature. Further, it is not necessary to make the heating end timing of the heater resistor MH1 and the heating end timing of the heater resistor MH2 completely coincide with each other; however, by making their heating end timings coincide with each other, it is possible to prevent the occurrence of unnecessary power consumption.

As illustrated in FIG. 3, during the dummy heating operation performed in period B, the heater resistors MH1 and MH2 are heated to 300° C. and 150° C., for example, under the control of the MPU 24.

During the dummy heating operation performed in period B, the heating start timing of the heater resistor MH1 is time t21, the heating start timing of the heater resistor MH2 is time t22, and the heating end timing of the heater resistors MH1 and MH2 is time t23. Thus, the heater resistor MH2 is heated during period T1 from time t22 to time t23, and the heater resistor MH1 is heated during period T2 from time t21 to time t23. This eliminates the thermal history difference between the thermistors Rd1 and Rd2 during the gas measurement operation performed in period A.

As described above, in period B, the heating of heater resistor MH1 to be heated to a higher temperature starts is started earlier than that of the heater resistor MH2, so that timings at which both the thermistors Rd1 and Rd2 are heated to their target temperatures can be made to substantially coincide with each other. Thus, as compared with when the heating of the heater resistors MH1 and MH2 is started simultaneously, the heating time of the heater resistor MH2 can be reduced to reduce power consumption. In addition, since the heating time of the heater resistor MH2 is thus reduced, the aging of the heater resistor MH2 can also be suppressed. Note that the detection signal is not sampled in period B, so that a period during which both the thermistors Rd1 and Rd2 are heated to their target temperatures need not exist. In other words, the period during which the heater resistor MH1 is heated and the period during which the heater resistor MH2 is heated need not overlap each other. Even in this case, by making heating period T1 of the heater resistor MH2 shorter than heating period T2 of the heater resistor MH1, it is possible to reduce power consumption.

As described above, in the gas sensor 1 according to the present embodiment, heating period T1 of the heater resistor MH1 is made shorter than heating period T2 of the heater resistor MH2 in period A during which the gas measurement operation is performed, while heating period T1 of the heater resistor MH2 is made shorter than heating period T2 of the heater resistor MH1 in period B during which the dummy heating operation is performed, thus making it possible to reduce power consumption and to suppress the aging of the thermistors Rd1 and Rd2.

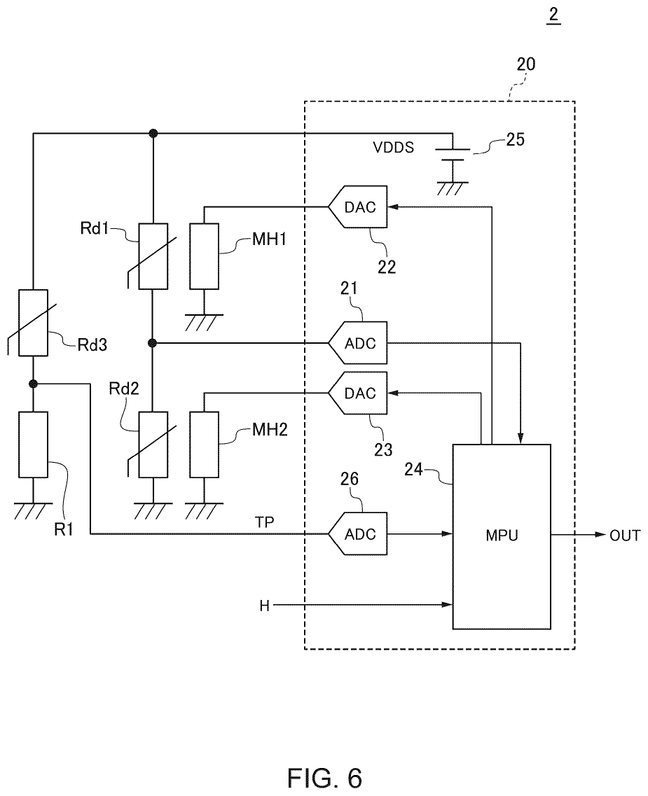

FIG. 6 is a circuit diagram illustrating the configuration of a gas sensor 2 according to a second embodiment of the technology described herein.

As illustrated in FIG. 6, the gas sensor 2 according to the second embodiment differs from the gas sensor 1 according to the first embodiment in that it further includes a thermistor Rd3 and a fixed resistor R1 and that the control circuit 20 further includes an AD converter 26. Other basic configurations are the same as those of the gas sensor 1 according to the first embodiment, so the same reference numerals are given to the same elements, and overlapping description will be omitted.

The thermistor Rd3 and fixed resistor R1 are connected in series between the power supply 25 and a ground, and a temperature signal TP appears at the connection point therebetween. The temperature signal TP is a signal indicating a current environmental temperature and is supplied to the AD converter 26. The AD converter 26 AD-converts the temperature signal TP and supplies the resultant signal to the MPU 24. The MPU 24 further receives a humidity signal H indicating a current environmental humidity.

In the present embodiment, the heating times of the heater resistors MH1 and MH2 are changed in period A during which the gas measurement operation is performed and in period B during which the dummy heating operation is performed based on the current environmental temperature indicated by the temperature signal TP or current environmental humidity indicated by the humidity signal H. That is, the lower the current environmental temperature indicated by the temperature signal TP is, the longer the time required for the thermistors Rd1 and Rd2 to reach their target temperatures becomes, so that the heating start timings of the heater resistors MH1 and MH2 are advanced, or the heating end timings of the heater resistors MH1 and MH2 are delayed so as to prolong the heating times of the heater resistors MH1 and MH2. Further, the higher the current environmental humidity indicated by the humidity signal H is, the higher the heat dissipation characteristics to the atmosphere become, and the longer the time required for the thermistors Rd1 and Rd2 to reach their target temperatures becomes, so that the heating start timings of the heater resistors MH1 and MH2 are advanced, or the heating end timings of the heater resistors MH1 and MH2 are delayed so as to prolong the heating times of the heater resistors MH1 and MH2.

While some embodiments of the technology according to the present disclosure have been described, the technology according to the present disclosure is not limited to the above embodiments, and various modifications may be made within the scope of the present disclosure, and all such modifications are included in the technology according to the present disclosure.

For example, although the measurement target gas is CO₂ gas in the above embodiments, the present invention is not limited to this. Further, the sensor part used in the present invention need not necessarily be a thermal conduction type sensor, but may be a sensor of other types such as a catalytic combustion type. As an example, when the measurement target gas is CO gas, a catalytic combustion type sensor part can be used.

The technology according to the present disclosure includes the following configuration examples, but not limited thereto.

A gas sensor according to the present disclosure includes: first and second thermistors connected in series; first and second heaters configured to heat the first and second thermistors, respectively; and a control circuit configured to control the first and second heaters. In a first period, the control circuit is configured to: heat the second heater to a higher temperature than a heating temperature of the first heater; generate an output signal indicating a concentration of a gas to be measured based on a detection signal appearing at a connection point between the first and second thermistors in a state where the second heater is heated to a higher temperature than the first heater; and make a heating time of the first heater shorter than a heating time of the second heater. This makes it possible to reduce power consumption and to suppress the aging of the first thermistor.

In the above gas sensor, in the first period, the control circuit may be configured to make a heating start timing of the first heater later than a heating start timing of the second heater. This makes it possible to reduce the difference between the timing at which the first thermistor is heated to its target temperature and the timing at which the second thermistor is heated to its target temperature.

In the above gas sensor, in the first period, the control circuit may be configured to make a heating end timing of the first heater and a heating end timing of the second heater coincide with each other. This can further reduce power consumption.

In the above gas sensor, in the first period, the control circuit may be configured to change the heating times of the first and second heaters based on an environmental temperature or an environmental humidity. This can optimize the heating time according to the environmental temperature or environmental humidity.

In the above gas sensor, in a second period, the control circuit may be configured to heat the first heater to a higher temperature than a heating temperature of the second heater and make the heating time of the second heater shorter than the heating time of the first heater. This makes it possible to reduce power consumption, to suppress the aging of the second thermistor, and to eliminate the thermal history difference between the first and second thermistors.

In the above gas sensor, in the second period, the control circuit may be configured to make a heating start timing of the second heater later than a heating start timing of the first heater. This makes it possible to reduce the difference between the timing at which the first thermistor is heated to its target temperature and the timing at which the second thermistor is heated to its target temperature.

In the above gas sensor, in the second period, the control circuit may be configured to make a heating end timing of the first heater and a heating end timing of the second heater coincide with each other. This can further reduce power consumption.

In the above gas sensor, in the second period, the control circuit may be configured to change the heating times of the first and second heaters based on an environmental temperature or an environmental humidity. This can optimize the heating time according to the environmental temperature or environmental humidity.

What is claimed is:

1. A gas sensor comprising:
first and second thermistors connected in series;
first and second heaters configured to heat the first and second thermistors, respectively; and
a control circuit configured to control the first and second heaters,
wherein, in a first period, the control circuit is configured to:
heat the second heater to a higher temperature than a heating temperature of the first heater;
generate an output signal indicating a concentration of a gas to be measured based on a detection signal appearing at a connection point between the first and second thermistors in a state where the second heater is heated to a higher temperature than the first heater; and
make a heating time of the first heater shorter than a heating time of the second heater.

2. The gas sensor as claimed in claim 1, wherein, in the first period, the control circuit is configured to make a heating start timing of the first heater later than a heating start timing of the second heater.

3. The gas sensor as claimed in claim 2, wherein, in the first period, the control circuit is configured to make a heating end timing of the first heater and a heating end timing of the second heater coincide with each other.

4. The gas sensor as claimed in claim 1, wherein, in the first period, the control circuit is configured to change the heating times of the first and second heaters based on an environmental temperature or an environmental humidity.

5. The gas sensor as claimed in claim 1, wherein, in a second period, the control circuit is configured to heat the first heater to a higher temperature than a heating temperature of the second heater and make the heating time of the second heater shorter than the heating time of the first heater.

6. The gas sensor as claimed in claim 5, wherein, in the second period, the control circuit is configured to make a heating start timing of the second heater later than a heating start timing of the first heater.

7. The gas sensor as claimed in claim 6, wherein, in the second period, the control circuit is configured to make a heating end timing of the first heater and a heating end timing of the second heater coincide with each other.

8. The gas sensor as claimed in claim 5, wherein, in the second period, the control circuit is configured to change the heating times of the first and second heaters based on an environmental temperature or an environmental humidity.
